(19) United States
(12) Patent Application Publication
(10) Pub. No.: US 2025/0343745 A1
(43) Pub. Date: Nov. 6, 2025

(54) Timing Window Determination for Mesh Fronthaul

(71) Applicant: Telefonaktiebolaget LM Ericsson (publ), Stockholm (SE)

(72) Inventors: Eduardo Lins de Medeiros, Sundbyberg (SE); Igor Almeida, Indaiatuba SP (BR); Balázs Varga, Budapest (HU); Gyanesh Patra, Santa Clara, CA (US); Per-Erik Eriksson, Stockholm (SE); János Farkas, Kecskemét (HU); Miguel Berg, Sollentuna (SE)

(21) Appl. No.: 18/656,022

(22) Filed: May 6, 2024

(51) Int. Cl. H04L 43/0852; H04W 40/02; H04W 40/24

(52) U.S. Cl. CPC H04L 43/0858; H04W 40/02; H04W 40/24

(57) ABSTRACT

A method performed by a network function is provided. The method is for handling a set of paths between a baseband node and a radio unit in a mesh fronthaul network of a communications network. The network function establishes a set of paths between ports in a port pair. The port pair comprises a port in the baseband node and port in the radio unit. The paths in the set of paths comprise different paths connected between the port in the baseband node and multiple endpoints associated with the port of the radio unit. Each path is associated with an individual path Identifier (ID). For each path out of the set of paths, the network function instructs (404) the baseband node or the radio unit, to perform a one-way delay measurement for the path associated with the individual path ID. The network function receives (405) results from the baseband node. The results relate to the one-way delay measurement performed for each path out of the set of paths. The network function determines how to use each path out of the set of paths based on the received results of the one-way delay measurements.

### TECHNICAL FIELD

Embodiments herein relate to a network function and methods therein. In some aspects, they relate to handling a set of paths between a baseband node and a radio unit in a mesh fronthaul network of a communications network.

### BACKGROUND

In a typical wireless communication network, wireless devices, also known as wireless communication devices, mobile stations, stations (STA) and/or User Equipment (UE), communicate via a Wide Area Network or a Local Area Network such as a Wi-Fi network or a cellular network comprising a Radio Access Network (RAN) part and a Core Network (CN) part. The RAN covers a geographical area which is divided into service areas or cell areas, which may also be referred to as a beam or a beam group, with each service area or cell area being served by a radio network node such as a radio access node e.g., a Wi-Fi access point, a Base Station (BS) or a radio base station (RBS), which in some networks may also be denoted, for example, a Base Station (BS), a NodeB, eNodeB (eNB), or gNodeB (gNB) as denoted in Fifth Generation (5G) telecommunications. A service area or cell area is a geographical area where radio coverage is provided by the radio network node. The radio network node communicates over an air interface operating on a radio frequency with the wireless devices within the range of the radio network node.

3rd Generation Partnership Project (3GPP) is the standardization body for specifying the standards for the cellular system evolution, e.g., including 3G, 4G, 5G and the future evolutions. Specifications for Evolved Universal Terrestrial Radio Access (E-UTRA) and Evolved Packet System (EPS) have been completed within the 3GPP. In 4G also called a Fourth Generation (4G) network, EPS is core network and E-UTRA is radio access network. In 5G, 5G Core (5GC) is core network, NR is radio access network. As a continued network evolution, the new release of 3GPP specifies a 5G network also referred to as 5G New Radio (NR) and 5GC.

Frequency bands for 5G NR are being separated into two different frequency ranges, Frequency Range 1 (FR1) and Frequency Range 2 (FR2). FR1 comprises sub-6 GHz frequency bands. Some of these bands are bands traditionally used by legacy standards but have been extended to cover potential new spectrum offerings from 410 MHz to 7125 MHz. FR2 comprises frequency bands from 24.25 GHz to 52.6 GHz. Bands in this millimeter wave range have shorter range but higher available bandwidth than bands in the FR1.

Multi-antenna techniques may significantly increase the data rates and reliability of a wireless communication system. For a wireless connection between a single user, such as UE, and a base station (BS), the performance is in particular improved if both the transmitter and the receiver are equipped with multiple antennas, which results in a Multiple-Input Multiple-Output (MIMO) communication channel. This may be referred to as Single-User (SU)-MIMO. In the scenario where MIMO techniques is used for the wireless connection between multiple users and the base station, MIMO enables the users to communicate with the base station simultaneously using the same time-frequency resources by spatially separating the users, which increases further the cell capacity. This may be referred to as Multi-User (MU)-MIMO. Note that MU-MIMO may benefit when each UE only has one antenna. The cell capacity can be increased linearly with respect to the number of antennas at the BS side. Due to that, more and more antennas are employed in BS. Such systems and/or related techniques are commonly referred to as massive MIMO.

### Fronthaul

In order to meet the increasing demand for data in recent mobile broadband networks, such as 5G systems, innovative and practical deployment solutions are required. For instance, 5G systems support network interfaces in a Centralized/Cloud Radio Access Network (C-RAN) architecture. Such interfaces support splitting of radio access functionality between a remote radio node and a baseband node.

A connection between a baseband node and a remote node may be referred to as a fronthaul link or fronthaul network. A commonly used interface over the fronthaul link is evolved Common Public Radio Interface (eCPRI). The fronthaul link may be used to carry baseband radio samples in packets, allowing the use of high volume, relatively low-cost Ethernet transceivers. Compression methods may be used in order to lower fronthaul bandwidth requirements. The fronthaul links may be based on Internet Protocol (IP) or Ethernet.

Adoption of packet-based links between base station nodes enables operators to achieve statistical multiplexing gains in their fronthaul infrastructure. As hinted above, fronthaul when used herein e.g., means a link or set of links connecting nodes used to implement a wireless access network. The nodes connected to fronthaul perform one or more functions that implement the physical layer of a wireless access network. One of the nodes connected to fronthaul performs Radio Frequency (RF) processing such as modulation, power amplification, analogue and digital processing of signals sent to and received from one or more antennas. This technology facilitates flexible deployments and enables different functional split architectures.

Current fronthaul solutions, built using Ethernet, do not benefit from mesh topologies. A mesh topology is a network configuration where devices are interconnected so that more than one connection, or physical paths, such as cables, fibre links may be used between two or more hosts connected to the network. A usual building practice is to set up a traffic engineered path between baseband node and radio unit, keeping it static throughout the lifetime of the deployment.

As sites have different capacities and different demands, e.g., different number of cells, users, different peak hours, the utilization of fronthaul links may be highly asymmetric, with uneven distribution of load per link. Some may be highly used and experience congestion while others may be lightly loaded.

Traditionally, an Ethernet network has a single path between any two endpoints, ensured by a spanning-tree algorithm, that prevents forwarding loops. One way to circumvent this is to use Virtual Local Area Network (VLAN) s. In this way it is possible to have two paths between the same endpoints if the VLAN IDs in each path are different.

In practical implementations, a fronthaul content is buffered before it is used to generate radio signals for transmission over the air interface. The buffer in the radio unit is limited and the transmission deadlines for Orthogonal Frequency Division Multiplexing (OFDM) symbols over the air interface are strict. To manage that, standards such as Open RAN (O-RAN) employ the concept of a delay window, Also known as transmission (TX) and reception (RX) window. See O-RAN Working Group 4 (Open Fronthaul Interfaces WG) Control, User and Synchronization Plane Specification v.13.00, O-RAN alliance, October 2023. In broad terms a delay window defines the earliest and latest times for sending data from a baseband node to radio unit or the other way around.

### O-RAN

Starting around 2020, industry discussions and investments into Open Radio Area Network (ORAN or O-RAN) initiatives have ramped up significantly. Many companies in the radio telecom industry is looking into ORAN technology. ORAN may provide opportunities to expand supplier diversity in the RAN vendor market and may lower operating costs by modularizing or disaggregating components in the access network. Industry wide adoption of open, interoperable interfaces defined by the O-RAN.

ORAN technology may enable use of common-off-the-shelf hardware/silicon and greater use of open-source software. In addition, ORAN technology may enable further automation (e.g., using AI) of increasingly complex networks, thereby simplifying operation and maintenance. In addition, certain government officials also view ORAN as a key technology to reducing national security risks that come from overreliance on foreign vendors and to fuel different national industries and initiatives in the radio telecom industry.

The most precise way to define a delay window size is to perform measurements in service, e.g., a one-way delay measurement. Other means are available, such as configuring the window directly (based on estimation, guidelines, etc.).

A mesh fronthaul network when used herein e.g. means a fronthaul network where a baseband node and a radio node are connected in a mesh network topology and can use more than one path for communication simultaneously.

An endpoint when used herein e.g. means a logical entity related to a radio element, such as a logical 3GPP channel, or radio reference point. An endpoint may represent a spatial stream, an antenna, etc. In general, one endpoint corresponds to one extended Antenna Carrier (eAxC)_Identifier (ID), e.g., an enhanced Common Public Radio Interface (eCPRI) antenna carrier identifier. An endpoint may also represent a processing element assigned to process radio content, e.g., a processor dedicated to processing Physical Uplink Shared Channel (PUSCH) for antennas.

An endpoint may be the origin endpoint or destination endpoint of one or more packet flows.

A port such as a physical ethernet port in a radio or baseband unit, is capable of hardware timestamping packets for one-way-delay measurement.

A port may be associated with multiple endpoints, but an endpoint may not be associated with multiple ports according to current O-RAN specifications. The number of endpoints is expected to be >>than the number of physical ports.

The following examples describe the relationships between transmit and receive windows in fronthaul, such as e.g., O-RAN.

For a given direction, e.g., downlink, there are two “windows” of interest, the transmission window, and the reception window. For downlink the reception is done by the radio unit while the transmission is done by the baseband node.

An air interface such as e.g., NR, or LTE, generates signals periodically, with a strict deadline. That is taken as a reference for definition of the windows as mentioned above.

The reception window for downlink accounts for a buffer size in a radio node. Given the fixed reference point, for transmission over the air, the reception window will start n microseconds before the deadline. Usually, the reception window is fixed and determined by memory and processing constraints at the receiving node, e.g., radio node for downlink.

Experiences of packet delay in fronthaul have a fixed component, e.g., propagation delay, serialization, etc., and a variable component due to queueing in packet forwarding nodes.

The transmit window at a sender node is set in such a way that given the worst-case delay in fronthaul, one way delay+waiting in packet forwarding nodes, the packets will still be delivered inside the reception window at the receiving node. If the transmitting node sends too late, the packet will no longer be relevant, e.g., arrives after deadline for transmission over the air.

The transmit window may also need to consider the case where there is no delay variation in the fronthaul, only the measured one-way delay. It cannot send too early otherwise the receiving node will not have space in its buffers.

In that way the transmit window may be adapted by how much one-way delay there is in the network. If there is more delay, the sender node needs to start sending, and computing, earlier. If there is less delay, the sender node can start sending and computing later.

Currently the O-RAN WG4 specifications do not support the use of multiple delay windows per endpoint. It is possible to use multiple paths between two physical ports by manually selecting which paths to use and assuring that their one-way delay is within bounds. The O-RAN WG4 is considering the term “delay profile” instead of “delay window” as used herein. In this document, they are equivalent and may be used interchangeably.

The procedure outlined above requires manual intervention with the spanning tree algorithm to ensure one could measure the one-way delay accordingly. The delay windows may be set based on assumptions, taking for example, fibre length into consideration, but that tends to not be the most accurate or convenient method.

### SUMMARY

As part of developing embodiments herein, the inventors identified some problems that first will be described.

In a fronthaul network, especially an O-RAN fronthaul network, it is possible to use multiple paths towards the same endpoint, if the single delay window is respected, e.g., the delay window covers the worst one-way delay of the paths.

From a deployment point of view the mesh may allow to distribute a capacity needed over multiple smaller links. This avoids overprovisioning the network and reduces the cost of infrastructure. The mesh may provide any-to-any connectivity. Regarding radio redundancy, it may remove a single point of failure in the network.

FIG. 1a depicts a fronthaul network, single path between baseband node BB1 and radio unit node RU1 via Packet Forwarding nodes (PFN). BB1 can only reach RU1 via a single path referred to as dashed arrows, even if they are physically connected in a mesh topology.

There is no procedure to determine a delay window that is sufficient for a group of paths.

Current specifications and proprietary implementations also do not support the concept of multiple delay windows between a baseband node and radio node.

An object of embodiments herein is to improve the handling of multiple paths in a mesh fronthaul network of a wireless communications network.

According to an aspect of embodiments herein, the object is achieved by a method performed by network function. The method is for handling a set of paths between a baseband node and a radio unit in a mesh fronthaul network of a communications network. The network function establishes a set of paths between ports in a port pair. The port pair comprises a port in the baseband node and port in the radio unit. The paths in the set of paths comprise different paths connected between the port in the baseband node and multiple endpoints associated with the port of the radio unit. Each path is associated with an individual path Identifier (ID). For each path out of the set of paths, the network function instructs the baseband node or the radio unit, to perform a one-way delay measurement for the path associated with the individual path ID. The network function receives results of the one-way delay measurement performed for each path out of the set of paths. The network function determines how to use each path out of the set of paths based on the received results of the one-way delay measurements.

According to another aspect of embodiments herein, the object is achieved by a network function. The network function is configured to handle a set of paths between a baseband node and a radio unit in a mesh fronthaul network of a communications network. The network function is further configured to:
Establish a set of paths between ports in a port pair. The port pair comprises a port in the baseband node and port in the radio unit. The paths in the set of paths are adapted to comprise different paths connected between the port in the baseband node and multiple endpoints associated with the port of the radio unit, where each path is adapted to be associated with an individual path Identifier, ID.
For each path out of the set of paths, instruct any one out of: the baseband node or the radio unit, to perform a one-way delay measurement for the path associated with the individual path ID.
Receive results of the one-way delay measurement performed for each path out of the set of paths, and
determine how to use each path out of the set of paths based on the received results of the one-way delay measurements.

Embodiments herein may provide one or more of the following advantages:

Provide a way to programmatically measure the one-way delay of individual paths in a mesh fronthaul topology.

Allow the exploitation of multiple paths between a baseband node physical port and a radio unit physical port. Exploiting multiple paths allows for better utilization of links in a topology, which in turn may lead to less congestion.

A way to select how many endpoints, and configure the respective values for delay windows, may be served between a baseband node physical port and a radio unit physical port. The outcome is better utilization of all links, also referred to as paths, and less probability of congestion.

Allow the usage of multiple physical ports between a baseband node and a radio node to serve a single endpoint.

### BRIEF DESCRIPTION OF THE DRAWINGS

Examples of embodiments herein are described in more detail with reference to attached drawings in which:

FIG. 1a is a schematic block diagram illustrating a fronthaul network according to prior art.

FIG. 1b is a schematic block diagram illustrating an example of a fronthaul network of embodiments herein.

FIG. 2a is a schematic block diagram illustrating embodiments of a communications network.

FIG. 2b is a schematic block diagram illustrating embodiments herein.

FIG. 3 is a schematic block diagram illustrating embodiments herein.

FIG. 4 is a flowchart depicting an embodiment of a method in a network function.

FIG. 5 is a flowchart depicting an embodiment of a method herein.

FIG. 6 is a schematic block diagram illustrating embodiments herein.

FIG. 7 is a schematic block diagram illustrating embodiments of a network function.

FIG. 8 schematically illustrates embodiments of a communication system.

FIG. 9 is a generalized block diagram of embodiments of a UE.

FIG. 10 is a generalized block diagram of embodiments of a network node.

FIG. 11 is a generalized block diagram of embodiments of a virtualization environment.

### DETAILED DESCRIPTION

Example embodiments herein may e.g., provide:
Means to effectively use multiple paths in a mesh fronthaul network, considering the restrictions the current O-RAN specification imposes, single delay window per endpoint.
Means to configure multiple endpoints between a baseband node and a radio unit while properly configuring delay windows for each endpoint.

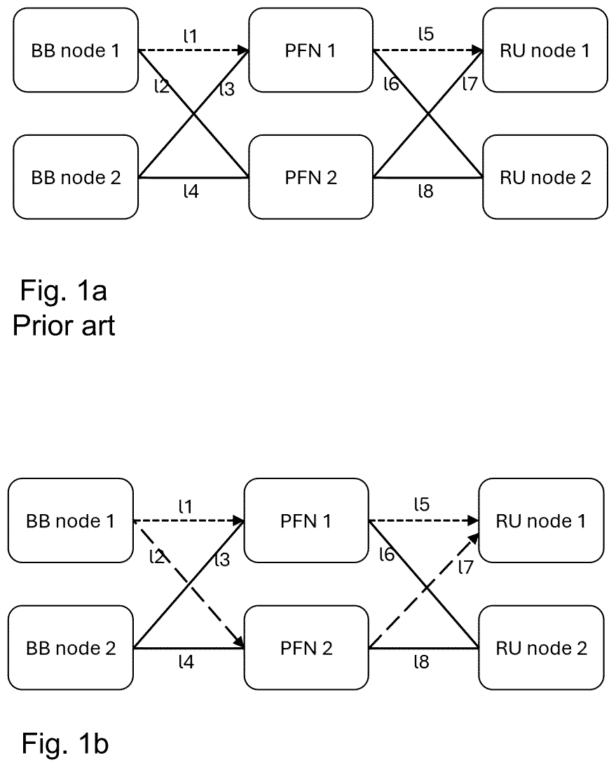

FIG. 1b depicts an example of embodiments herein comprising a fronthaul with two paths in use between BB1 and RU1. BB1 can reach RU1 via two distinct paths referred to as dashed arrows.

Example embodiments herein provide a method for measuring one-way delay for paths in mesh fronthaul deployments. Based on said measurements, e.g.:

Determine a representative maximum one-way delay value for a set of paths that would allow paths in the set to be used simultaneously between a radio unit and a baseband node.

Determine the number of endpoints that may be supported by exploring a set of paths between a pair of ports and determine the delay window size for each endpoint. Exploring a set of paths may mean to measure the one-way delay for each path in the set of paths, performing a clustering operation on the measurements, identifying a number of relevant clusters, configuring one endpoint at the radio for each cluster, configuring the delay window for each of the endpoints. The transmit and reception window relationship is referred to as delay window herein. When a delay window is configured for a given port in radio, the baseband is e.g., told when to start and end transmission given a certain measured one-way delay between the sending and receiving ports.

Determine which groups of baseband and radio ports that may be used to serve a given endpoint in a radio unit, e.g., using multiple paths in the mesh network simultaneously.

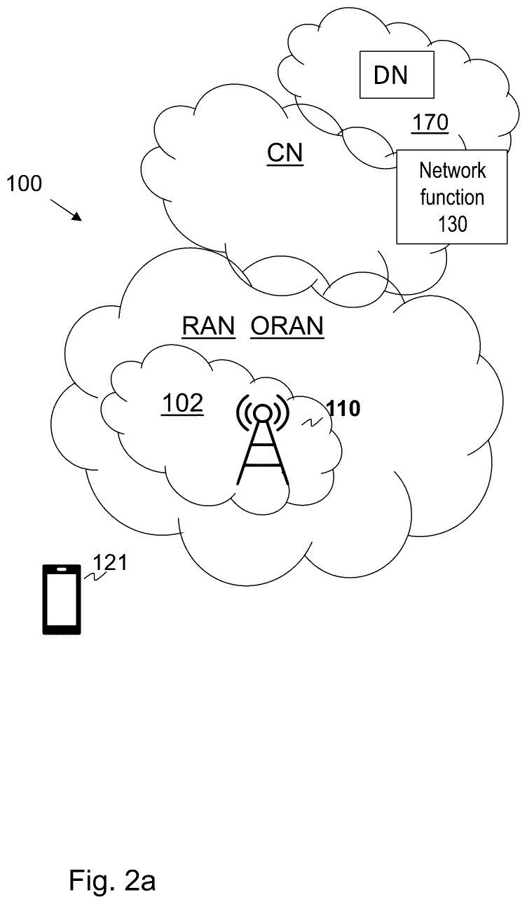

FIG. 2a is a schematic overview depicting a communications network 100 wherein embodiments herein may be implemented. The wireless communications network 100 comprises a RAN, and a CN. The communications network 100 may use 5G NR but may further use a number of other different technologies, such as, 6G, Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations. The RAN may be implemented by nodes connected to a mesh topology fronthaul network. The nodes implementing the RAN may be O-RAN compliant. of the communications network 100. The mesh fronthaul network 102 will be described more in detail below.

Base stations, such as a base station 110, operate in the RAN, the ORAN and/or the mesh fronthaul network 102 in the communications network 100. The base station 110 may be a transmission and reception point e.g. a radio access network node such as a base station, e.g. a radio base station such as a NodeB, an evolved Node B (eNB, eNode B), an NR Node B (gNB), a base transceiver station, a radio remote unit, an Access Point Base Station, a base station router, a transmission arrangement of a radio base station, a stand-alone access point, a Wireless Local Area Network (WLAN) access point or an Access Point Station (AP STA), an access controller, or any other network unit capable of communicating with UEs, such as a UE 121, within a cell, served by the base station 110. The base station 110 may be referred to as a serving radio network node and may communicate with the UE 121 with Downlink (DL) transmissions to the UE 121 and Uplink (UL) transmissions from the UE 121.

The RAN is composed of a baseband and radios. The baseband nodes and radio nodes may be compliant with O-RAN specifications. These are referred to as O-DU and O-RU respectively.

Embodiments herein are applicable for O-RAN compliant nodes but also for regular baseband and radios that are not O-RAN compliant.

One or more UEs operate in the wireless communication network 100, such as e.g. the UE 121. The UE 121 may e.g. be 5G-RG, an AR device, a remote UE, a wireless device, an NR device, a mobile station, a wireless terminal, an NB-IoT device, an MTC device, an eMTC device, a CAT-M device, a WiFi device, an LTE device and an a non-access point (non-AP) STA, a STA, that communicates via a base station such as e.g. a base station 110, one or more Access Networks (AN), e.g. the RAN and/or ORAN, to one or more CN nodes, in one or more CNs. It should be understood by the skilled in the art that “UE” is a non-limiting term which means any terminal, client, mobile client, IMS client, wireless communication terminal, user equipment, Device to Device (D2D) terminal, or node e.g. smart phone, laptop, mobile phone, sensor, relay, mobile tablets or even a car or any small base station communicating within a cell.

Methods according to embodiments herein are performed by the network function 130. This function node 130 may be a Distributed Nodes (DN) and functionality, e.g. comprised in a cloud 170 as shown in FIG. 2a.

Network functions such as a network function 130, operate in the wireless communications network 100. The network function 130 may e.g. be a VLAN Configuration and Characterization Network Function (VCC-NF).

### Involved Nodes.

As hinted above, the RAN may be implemented by O-RAN compliant nodes, such as an O-DU and O-RU. The nodes involved in embodiments herein are comprised in the mesh fronthaul network 102 depicted in FIG. 2b. The networking topology is a non-limiting example. In FIG. 2 dashed lines indicate logical interfaces, while solid lines indicate networking such as e.g. Ethernet links. FIG. 2 illustrates an example of connections and relationship of these involved nodes which e.g. comprise one or more of the following nodes. The base station 110 may comprise a baseband node 111 and radio units 112.

The baseband node 111 (BN), also referred to as an O-RAN distributed unit (O-DU), which wordings may be used interchangeably. The baseband node 111 may e.g., be virtualized, i.e., it does not have to be a physical node but may be a virtual node in a server or in the cloud 170.

The Radio units 112 (RU), also referred to as an O-RAN radio unit (O-RU), which wordings may be used interchangeably.

Packet forwarding nodes 131 also referred to as switching or routing nodes which wordings may be used interchangeably. The packet forwarding nodes 131 may e.g., Ethernet switches, or Internet Protocol (IP) routers.

The network function 130, which e.g. may be a VLAN configuration and characterization network function (VCC-NF). The network function 130 performs the provided method. The VCC-NF may reside in an Software-Defined Networking SDN controller or be implemented as an SDN controller.

A radio network node such as the base station 110 may be implemented in a distributed fashion, e.g. using a Centralised/Cloud Radio Access Network (C-RAN) architecture. The base station 110 may comprise a baseband node 111, e.g., being a baseband processing unit and one or more (in this example two), e.g., remote radio units 112. When applied in an O-RAN architecture, the baseband node may be an O-DU node and the radio units 112 may be an O-RU node. The baseband node 111 and the remote radio units 112 may be in different locations. The baseband node 111 may be located uplink from the remote radio units 112, i.e. towards the CN. Consequently, the remote radio units 112 are located downlink from the baseband node 11, towards the UE 121. There are respective fronthaul links between the baseband node 111 and the remote radio units 112. The fronthaul links may be bidirectional communication links. The fronthaul links may be implemented using a Common Public Radio Interface (CPRI) or eCPRI (evolved CPRI) and Ethernet, or IP (Internet Protocol). Multiple fronthaul links may be employed in other topologies than what is shown in FIG. 2b. Multiple fronthaul links may also be denoted a fronthaul network. The baseband node 111 and the radio units 112 may each implement subsets of functionality for radio communication with UEs such as the UE 121. Furthermore, some functionality for the radio communication may be virtualized, also known as cloud RAN.

The base station may be implemented by at least one O-DU (O-RAN (Open RAN) distributed unit) and at least one O-RU (O-RAN radio unit).

Example embodiments herein provide methods for defining delay window(s) in the mesh fronthaul network 102. Examples herein are presented for Ethernet based mesh fronthaul networks, but the methods may also work for networks implemented over an Internet Protocol (IP), such as e.g., IPv4, and IPV6.

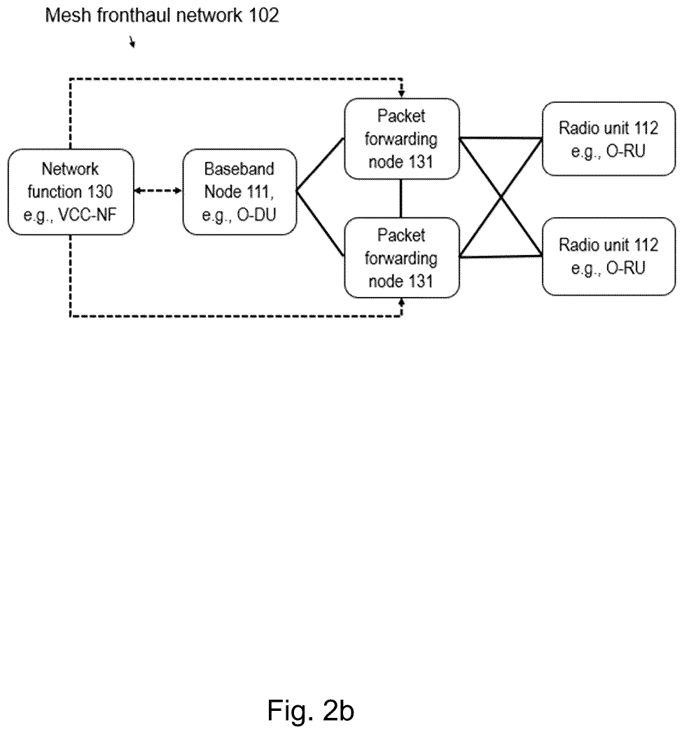

FIG. 3 depicts an example scenario of embodiments herein. In this example, the baseband node 111 comprises one or more ports and the radio unit 112 comprises one or more ports. In the example scenario each port in the radio unit 112 comprises multiple endpoints represented by black bullets in the figure.

A set of paths are established between ports in a port pair. The method may be implemented with one port pair, however, two port pairs are depicted in FIG. 3. The port pair comprises a port in the baseband node 111 and a port in the radio unit 112. The paths in the set of paths are spread between the port in the baseband node 111 and multiple endpoints associated with the port of the radio unit 112.

A number of embodiments will now be described, some of which may be seen as alternatives, while some may be used in combination.

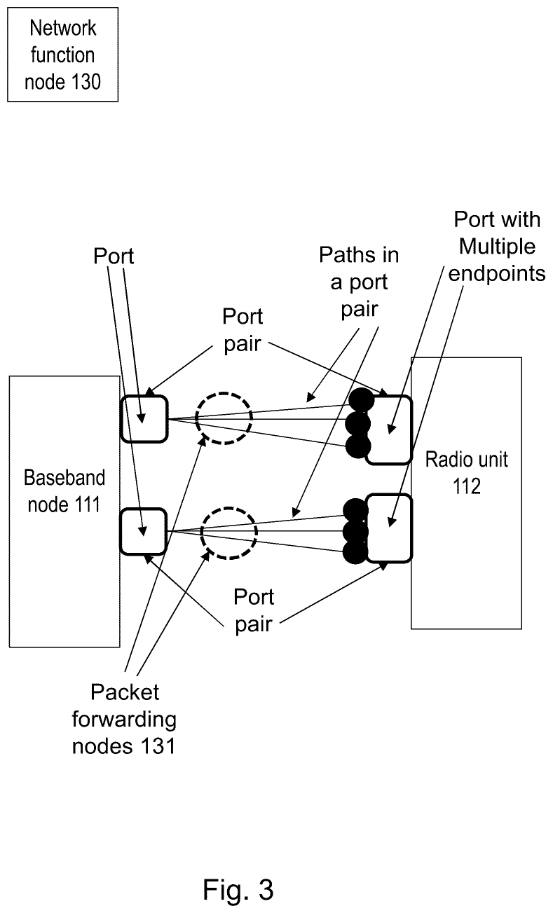

FIG. 4 shows examples of embodiments of a method performed by a network function 130, e.g., VCC-NF. The method is for handling a set of paths between the baseband node 111 and the radio unit 112 in a mesh fronthaul network 102 of a communications network 100. A path when used herein e.g., means one or more network links connecting two nodes. A link is exemplified by the labels l1, l2, . . . , l8 in FIG. 1b. A path is an ordered set of links such as the two distinct paths that are exemplified by {l1, l5}, {l2, l7} in Figure b. Any two paths may share one or more network links. For this example, in in FIG. 1b, the path {l1, l5} and the path {l2, l7} connects baseband node 1 to radio node 1. A path is distinct from another path if their set of network segments have different elements or are not in the same order.

Referring again to FIG. 4. The method comprises the following actions, which actions may be taken in any suitable order. Optional actions are referred to as dashed boxes in FIG. 4.

Action 401. In some embodiments, the network function 130 obtains information about a number of port pairs, between ports in the baseband node 111 and ports in the radio unit 112. A port pair when used herein e.g., represents the end points between which a number of paths for one or more packet flows ranges.

Action 402. The network function 130 establishes a set of paths between ports in a port pair. The port pair comprises a port in the baseband node 111 and port in the radio unit 112. The paths in the set of paths comprises different paths connected between the port in the baseband node 111 and multiple endpoints associated with the port of the radio unit 112. Each path is associated with an individual path Identifier (ID). The individual path ID may e.g. be a VLAN ID,

In some embodiments, there are set of paths between respective port pair out of multiple port pairs, a number of port pairs, see e.g., FIG. 3. In these embodiments, the establishing of the set of paths between the ports of the port pair comprises: Establishing a set of paths for each port pair out of the number of port pairs.

Action 403. In some embodiments, the network function 130 configures a packet forwarding node 131 related to the path. The packet forwarding node 131 is configured with the individual path ID assigned to the path. This is performed for each path out of the set of paths. This is e.g., performed to ensure that traffic is properly forwarded or routed to the correct path with the assigned path ID. The paths may be formed via configuration of the packet forwarding nodes. The packet forwarding node may be responsible for matching incoming traffic with certain characteristics to a path with an assigned ID. For example, if the path ID is a VLAN ID, the packets will be tagged with that VLAN ID at the source and the packet forwarding nodes will route incoming traffic with that VLAN ID to the correct ports so that the packets follow the intended path in the topology towards the destination host. Other path identifiers may be used depending on the packet forwarding node implementation, for example a flow ID in IPV6.

Action 404. The network function 130 instructs a first node to perform a one-way delay measurement for the path associated with the individual path Identifier ID. This is performed for each path out of the set of paths. The first node is represented by anyone out of: the baseband node 111 and the radio unit 112. The one-way delay measurement is e.g., needed to establish the minimum and maximum transmit times for a packet or group of packets between nodes connected to the fronthaul. Usually there is a fixed deadline for when the packets should be available at the receiving node (e.g., radio node). If the packets arrive too early the receiving node may run out of buffer space to store and process it. If the packets arrive too late, they will not be relevant anymore. Therefore, by measuring the one-way delay, the sender may adjust its delay window (the proper interval for transmission to an endpoint.

In practical implementations, fronthaul content may be buffered before it is used to generate radio signals for transmission over the air. The buffer in the radio unit 112 is limited and the transmission deadlines for OFDM symbols over the air are strict. To manage that, standards such as O-RAN employ the concept of a delay window. In broad terms these may define the earliest and latest times for sending data from baseband to radio or the other way around.

Action 405. The network function 130 receives results from the first node. The results relate to the one-way delay measurement performed for each path out of the set of paths.

The results may e.g. be received from the baseband node 111 and/or the radio unit 112.

Action 406. The network function 130 determines how to use each path out of the set of paths based on the received results of the one-way delay measurements. This may e.g. be for an upcoming data transmission between the baseband node 111 and the radio unit 112.

In some embodiments, the determining of how to use the paths of the set of paths, comprises: Based on identifying a worst-case one-way delay between a set of paths for the port pair, determining to configure a single delay window and use all paths in between said port pair simultaneously. This e.g., means that the sending node, e.g., the baseband node 111, may send a set of packets using more than one path in the set of paths in such a way that they will arrive at the receiver at a favourable moment, inside the receive window, in other words, not too early, not too late. By using more than one path, the overall load in the set of paths will be lower than if a single path was used.

The network function 130 may determine how to use the paths of the set of paths, by clustering paths into a number of path clusters based on the one-way delay between the set of paths for a port pair. The network function 130 may then determine the number of endpoints with separate one-way delay windows that the port pair supports based on the resulting number of path clusters. This e.g., means that the baseband node 111, e.g., O-DU, would be able to configure a set of endpoints, such as e.g., logical terminations in the radio node, and use them independently. Usually, different endpoints serve a different purpose for the distributed baseband implementation. One endpoint may serve traffic for the shared channel in the radio protocol, while a second may serve traffic for measurements and a third may serve slower control messages. Given the different usages for each endpoint, in general, their traffic requirements are diverse, e.g., measurements may be buffered, while the shared channel may not. By knowing how many endpoints there are and their traffic requirements (constraints) the sending node, e.g., baseband node 111 may optimize the usage of its physical ports.

So, by knowing that a set of paths have the same delay they may be used simultaneously between the baseband node 111 and radio unit 112 because they may be configured with the same delay window. Sending over several paths could be used for load balancing or resilience through redundancy.

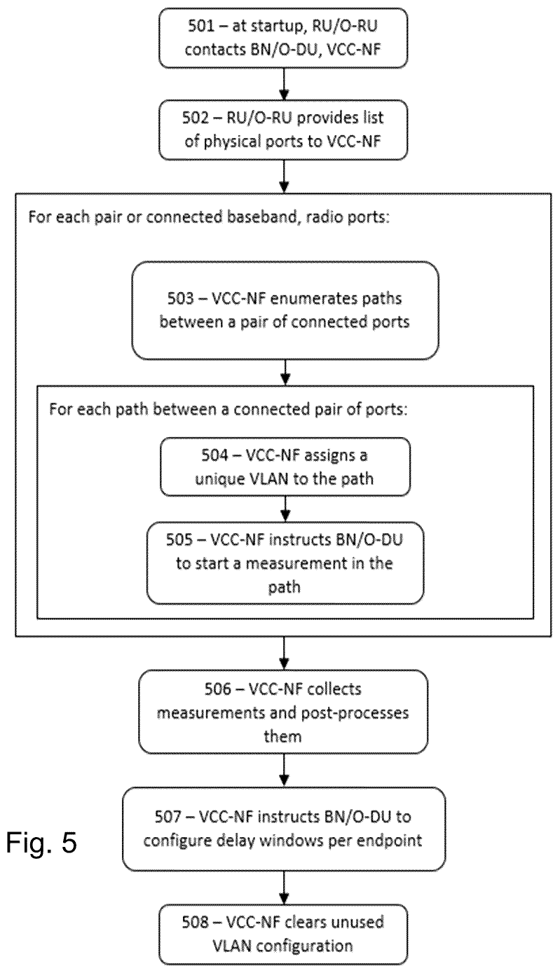

The network function 130 may in some embodiments determine how to use each path out of the set of paths by clustering paths into of a number of path clusters based on the one-way delay between the set of paths for each port pair out of the number of port pairs. The network function 130 may then determine to use the paths that are clustered together in the number of path clusters to transmit towards anyone out of: the same endpoint or the same port in the radio unit 112, using the same delay window from two or more physical ports using multiple paths. This e.g., means that two sending nodes, e.g., baseband node 111 may cooperate to serve another node cooperatively. One example is when different basebands may generate fronthaul traffic for one carrier, or bandwidth part, and both carriers, or bandwidth parts, would be served by the same radio simultaneously. Another example is when a radio unit 112 may send measurements towards multiple basebands e.g., baseband node 111, for interference management or channel estimation purposes. This is described more in detail below together with FIG. 6.

Action 407. The network function 130 may then send an instruction to the baseband node 111, to configure a delay window for the port in the radio unit 112 according to the determined usage of each path out of the set of paths. This is e.g., performed by configuring a delay window to a value. The baseband node 111 may have set bounds for when to start and when to end sending packets to the chosen radio unit port. The delay window may be defined by considering the reception window at the radio unit 112, the maximum delay variation in transport and the measured one-way delay for the bath between baseband node 111 and the radio unit 112.

In some embodiments, the sending of the instruction to the baseband node 111, to configure a delay window for the port in the radio unit 112 according to the determined usage of each path out of the set of paths, is performed for each port pair out of the number of port pairs.

Embodiments herein such as the embodiments mentioned above will now be further described and exemplified. The text below is applicable to and may be combined with any suitable embodiment described above.

The method may assume that the network topology of the mesh fronthaul network 102 is available to the network function 130, such as e.g. the VCC-NF.

The method may assume that network function 130, such as e.g. the VCC-NF has information about the physical ports, also referred to as ports herein, in the baseband node 111 of interest, also about the physical ports in the radio units 112 of interest. In general, information may be needed about all ports that are considered to be connected.

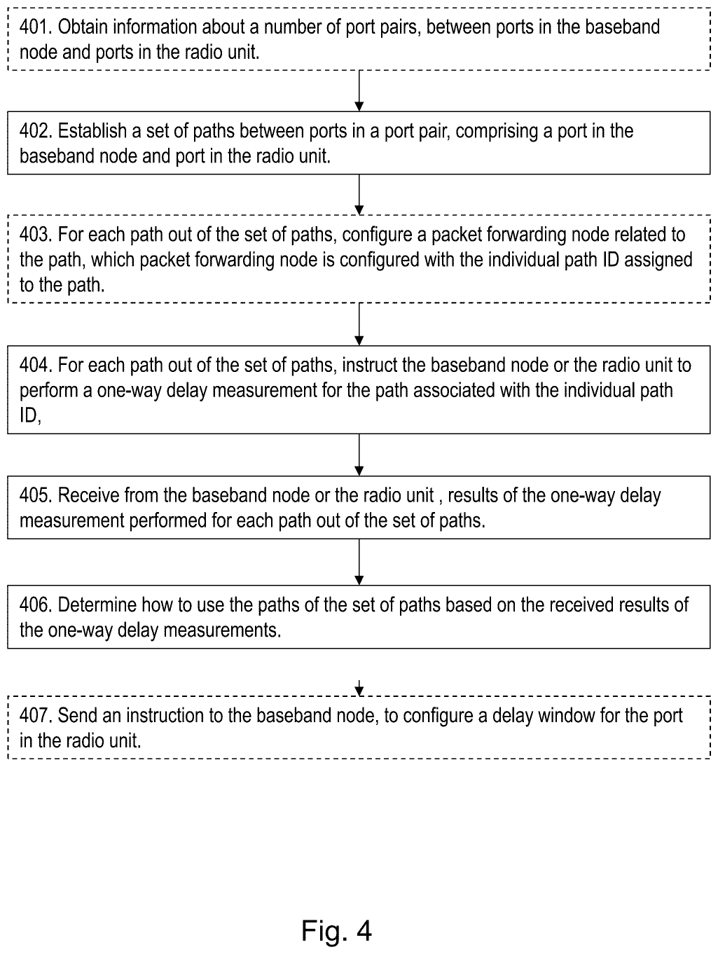

An example of the method is illustrated in flowchart in FIG. 5. In this description, the terms baseband node 111 and radio node 112 are used interchangeable way with O-DU, O-RU, respectively. In FIG. 5 the network function 130 is referred to as VCC-NF.

501. When a radio node 112 is started-up and has not been configured yet, it may identify itself to the baseband node 111 and network function 130 such as the VCC-NF.

502. A list of physical ports may be provided from the radio node 112 to the network function 130. Alternatively, the network function 130 may query the radio node for its physical ports information directly. This is related to and may be combined with Action 401 described above.

For each pair of connected baseband, radio ports the network function 130 may: Connected may here denote that from port “a” in the baseband node 111 it is possible to reach port “b” in the radio unit 112 and vice-versa.

503. Enumerate the paths between the pair of ports. The enumeration may ignore paths with special characteristics, e.g., that are too long, or that are more than k hops long, where k is an implementation parameter. This may be determined, for example, by knowledge of the deployment characteristics, fibre lengths, etc.

This is related to and may be combined with Action 402 described above.

504. Assign an individual path ID, such as a unique VLAN ID or a unique flow identifier, to the path. The network function 130 may configure the relevant packet forwarding nodes 131 such as e.g., switching nodes so that the selected VLAN ID is assigned to the desired path. A configuration of VLANs may be performed using management protocols for the packet forwarding nodes 131 such as the switching nodes in the deployment. The Ethernet Local Management Interface (E-LMI) protocol may be used to inform the endpoints such as the radio unit 112 and the baseband node 111 of VLANs that are available after performing the configuration. This is related to and may be combined with Action 403 described above.

505. The network function 130 instructs the baseband node 111 or the radio unit 112, to start a one-way delay measurement for the pair of ports with the VLAN configured in the previous step. This is related to and may be combined with Action 404 described above. The Results are collected or informed to the network function 130. This is related to and may be combined with Action 405 described above.

506. After completing the measurements, the network function 130 post-processes the results to produce the following outcomes: This is related to and may be combined with Action 406 described above.

In some embodiments, the network function 130 finds a worst-case one-way delay between a set of paths for a (single) pair of ports. The resulting value is useful to configure a single window but use all paths in between said pair of ports simultaneously.

In some embodiments, the network function 130 performs clustering on the one-way delay between a set of paths for a single pair of ports. The resulting number of clusters suggests how many endpoints, with separate one-way delay windows that pair of ports may support. The worst one-way delay in each cluster may be used to define the respective delay window value.

In one embodiment, the network function 130 performs clustering on the one-way delay between paths for all ports. Paths that are clustered together can be used to transmit towards the same endpoint, using the same delay window, from two or more physical ports, using multiple paths. This embodiment is illustrated in FIG. 6.

507. The network function 130 instructs the baseband node 111 to configure the delay windows for each endpoint of interest according to the outcomes of the previous step. This is related to and may be combined with Action 407 described above.

508. After configuring the timing windows and the respective end-to-end paths with individual path IDs such as unique VLAN IDs, the network function 130 may collect the set of unused individual path IDs and remove them from the configuration of the packet forwarding nodes 131 and releasing them for other uses. An individual path ID such as a VLAN ID mapped to a unique end-to-end path between two ports, may be left unused e.g., because its measured latency was excessive.

### Cloud Implementation

The network function 130 and all methods provided herein may be implemented as cloud applications, running in virtualized environments, or in distributed servers.

### O-RAN Implementation

The methods provided herein target an O-RAN architecture. The baseband node 111 and radio units 112 mentioned above may correspond to O-DU and O-RU respectively.

### Technical Specification Impact

The use of multiple delay windows is currently not supported in O-RAN WG4 specifications, but embodiments herein may be a precedent for it.

To perform the method actions above, the network function 130 is configured to handle a set of paths between the baseband node 111 and the radio unit 112 in the mesh fronthaul network 102 of a communications network 100.

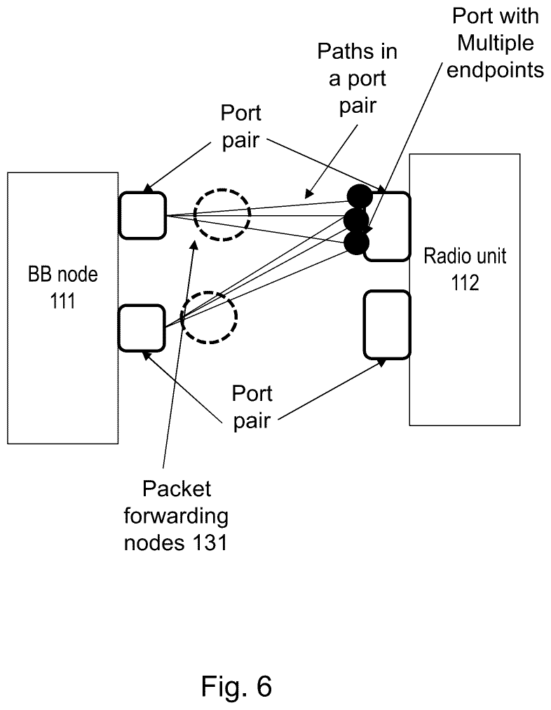

The network function 130 may comprise an arrangement depicted in FIG. 7. The network function 130 may comprise an input and output interface 700 configured to communicate in the communications network 100, e.g., with the baseband node 111 and/or the radio unit 112. The input and output interface 700 may comprise a wireless receiver not shown, and a wireless transmitter not shown.

The network function 130 is further being configured to establish a set of paths between ports in a port pair. The port pair comprises a port in the baseband node 111 and port in the radio unit 112. The paths in the set of paths are adapted to comprise different paths connected between the port in the baseband node 111 and multiple endpoints associated with the port of the radio unit 112, where each path is adapted to be associated with an individual path Identifier, ID.

The network function 130 is further configured to for each path out of the set of paths, instruct a first node to perform a one-way delay measurement for the path associated with the individual path ID. The first node is represented by anyone out of: the baseband node 111 and the radio unit 112.

The network function 130 is further configured to receive results of the one-way delay measurement performed for each path out of the set of paths.

The network function 130 is further configured to determine how to use each path out of the set of paths based on the received results of the one-way delay measurements.

The network function 130 may further be configured to send an instruction to the baseband node 111, to configure a delay window for the port in the radio unit 112 according to the determined usage of each path out of the set of paths.

The network function 130 may further be configured to determine how to use each path out of the set of paths by, based on identifying a worst-case one-way delay between a set of paths for the port pair, determine to configure a single delay window and use all paths in between said port pair simultaneously.

The network function 130 may further be configured to determine how to use the paths of the set of paths, by: clustering paths into a number of path clusters based on the one-way delay between the set of paths for a port pair, and determining the number of endpoints with separate one-way delay windows that the port pair supports based on the resulting number of path clusters.

The network function 130 may in some embodiments, further be configured to obtain formation about a number of port pairs, between ports in the baseband node 111 and ports in the radio unit 112. The network function 130 may in these embodiments, further be configured to establish the set of paths between the ports of the port pair by establishing a set of paths for each port pair out of the number of port pairs, and send the instruction to the baseband node 111, to configure a delay window for the port in the radio unit 112 according to the determined usage of each path out of the set of paths, by sending the instruction for each port pair out of the number of port pairs.

The network function 130 may in some embodiments, further be configured to determine how to use each path out of the set of paths by clustering paths into of a number of path clusters based on the one-way delay between the set of paths for each port pair out of the number of port pairs, and determining to use the paths that are clustered together in the number of path clusters to transmit towards anyone out of: the same endpoint or the same port in the radio unit 112, using the same delay window from two or more physical ports using multiple paths.

The network function 130 may further be configured to, for each path out of the set of paths, configure a packet forwarding node 131 related to the path, which packet forwarding node 131 is adapted to be configured with the individual path ID assigned to the path.

Embodiments herein may be implemented through a respective processor or one or more processors, such as the respective processor 710 of a processing circuitry in the network function 130 depicted in FIG. 7, together with a computer program code for performing the functions and actions of the embodiments herein. The program code mentioned above may also be provided as a computer program product, for instance in the form of a data carrier carrying computer program code for performing the embodiments herein when being loaded into the network function 130. One such carrier may be in the form of a CD ROM disc. It is however feasible with other data carriers such as a memory stick. The computer program code may furthermore be provided as pure program code on a server and downloaded to the network function 130.

The network function 130 may further comprise a memory 720 comprising one or more memory units. The memory 720 comprises instructions executable by the processor in the respective network function 130. The memory 720 are arranged to be used to store e.g., paths, media functions, indications, tags, information, data, configurations, communication data, and applications to perform the methods herein when being executed in the network function 130.

In some embodiments, a computer program 730 comprises instructions, which when executed by the respective at least one processor 710, cause the at least one processor of the network function 130 to perform the actions above.

In some embodiments, a respective carrier 740 comprises the computer program 730, wherein the carrier 740 is one of an electronic signal, an optical signal, an electromagnetic signal, a magnetic signal, an electric signal, a radio signal, a microwave signal, or a computer-readable storage medium.

Those skilled in the art will appreciate that units in the network function 130 described above may refer to a combination of analog and digital circuits, and/or one or more processors configured with software and/or firmware, e.g. stored in the network function 130, that when executed by the respective one or more processors such as the processors described above. One or more of these processors, as well as the other digital hardware, may be included in a single Application-Specific Integrated Circuitry ASIC, or several processors and various digital hardware may be distributed among several separate components, whether individually packaged or assembled into a System-on-a-Chip (SoC).

### Additional Explanation

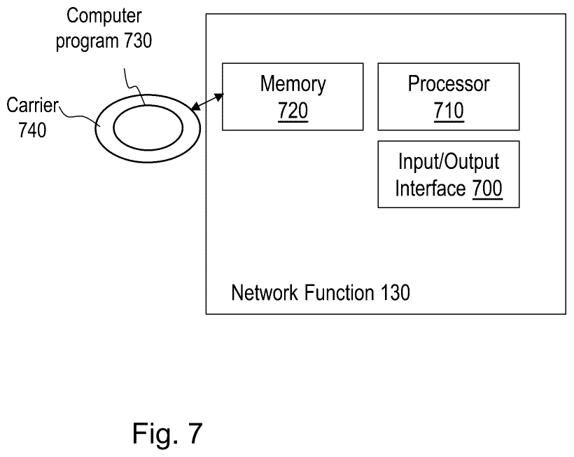

FIG. 8 shows an example of a communication system QQ100 in accordance with some embodiments.

In the example, the communication system QQ100 includes a telecommunication network QQ102 that includes an access network QQ104, such as a radio access network (RAN), and a core network QQ106, which includes one or more core network nodes QQ108. The access network QQ104 includes one or more access network nodes, such as network nodes QQ110a and QQ110b (one or more of which may be generally referred to as network nodes QQ110), or any other similar 3rd Generation Partnership Project (3GPP) access nodes or non-3GPP access points. Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network QQ102 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network QQ102, including one or more network nodes QQ110 and/or core network nodes QQ108.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes QQ110 facilitate direct or indirect connection of user equipment (UE), such as by connecting UEs QQ112a, QQ112b, QQ112c, and QQ112d (one or more of which may be generally referred to as UEs QQ112) to the core network QQ106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system QQ100 may include any number of wired or wireless networks, network nodes, UEs, and/or any other components or systems that may facilitate or participate in the communication of data and/or signals whether via wired or wireless connections. The communication system QQ100 may include and/or interface with any type of communication, telecommunication, data, cellular, radio network, and/or other similar type of system.

The UEs QQ112 may be any of a wide variety of communication devices, including wireless devices arranged, configured, and/or operable to communicate wirelessly with the network nodes QQ110 and other communication devices. Similarly, the network nodes QQ110 are arranged, capable, configured, and/or operable to communicate directly or indirectly with the UEs QQ112 and/or with other network nodes or equipment in the telecommunication network QQ102 to enable and/or provide network access, such as wireless network access, and/or to perform other functions, such as administration in the telecommunication network QQ102.

In the depicted example, the core network QQ106 connects the network nodes QQ110 to one or more host computing systems, such as host QQ116. These connections may be direct or indirect via one or more intermediary networks or devices. In other examples, network nodes may be directly coupled to hosts. The core network QQ106 includes one more core network nodes (e.g., core network node QQ108) that are structured with hardware and software components. Features of these components may be substantially similar to those described with respect to the UEs, network nodes, and/or hosts, such that the descriptions thereof are generally applicable to the corresponding components of the core network node QQ108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host QQ116 may be under the ownership or control of a service provider other than an operator or provider of the access network QQ104 and/or the telecommunication network QQ102. The host QQ116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system QQ100 of 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network QQ102 is a cellular network that implements 3GPP standardized features. Accordingly, the telecommunications network QQ102 may support network slicing to provide different logical networks to different devices that are connected to the telecommunication network QQ102. For example, the telecommunications network QQ102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs QQ112 are configured to transmit and/or receive information without direct human interaction. For instance, a UE may be designed to transmit information to the access network QQ104 on a predetermined schedule, when triggered by an internal or external event, or in response to requests from the access network QQ104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub QQ114 communicates with the access network QQ104 to facilitate indirect communication between one or more UEs (e.g., UE QQ112c and/or QQ112d) and network nodes (e.g., network node QQ110b). In some examples, the hub QQ114 may be a controller, router, content source and analytics, or any of the other communication devices described herein regarding UEs. For example, the hub QQ114 may be a broadband router enabling access to the core network QQ106 for the UEs. As another example, the hub QQ114 may be a controller that sends commands or instructions to one or more actuators in the UEs. Commands or instructions may be received from the UEs, network nodes QQ110, or by executable code, script, process, or other instructions in the hub QQ114. As another example, the hub QQ114 may be a data collector that acts as temporary storage for UE data and, in some embodiments, may perform analysis or other processing of the data. As another example, the hub QQ114 may be a content source. For example, for a UE that is a VR device, display, loudspeaker, or other media delivery device, the hub QQ114 may retrieve VR assets, video, audio, or other media or data related to sensory information via a network node, which the hub QQ114 then provides to the UE either directly, after performing local processing, and/or after adding additional local content. In still another example, the hub QQ114 acts as a proxy server or orchestrator for the UEs, in particular if one or more of the UEs are low energy IoT devices.

The hub QQ114 may have a constant/persistent or intermittent connection to the network node QQ110b. The hub QQ114 may also allow for a different communication scheme and/or schedule between the hub QQ114 and UEs (e.g., UE QQ112c and/or QQ112d), and between the hub QQ114 and the core network QQ106. In other examples, the hub QQ114 is connected to the core network QQ106 and/or one or more UEs via a wired connection. Moreover, the hub QQ114 may be configured to connect to an M2M service provider over the access network QQ104 and/or to another UE over a direct connection. In some scenarios, UEs may establish a wireless connection with the network nodes QQ110 while still connected via the hub QQ114 via a wired or wireless connection. In some embodiments, the hub QQ114 may be a dedicated hub—that is, a hub whose primary function is to route communications to/from the UEs from/to the network node QQ110b. In other embodiments, the hub QQ114 may be a non-dedicated hub—that is, a device which is capable of operating to route communications between the UEs and network node QQ110b, but which is additionally capable of operating as a communication start and/or end point for certain data channels.

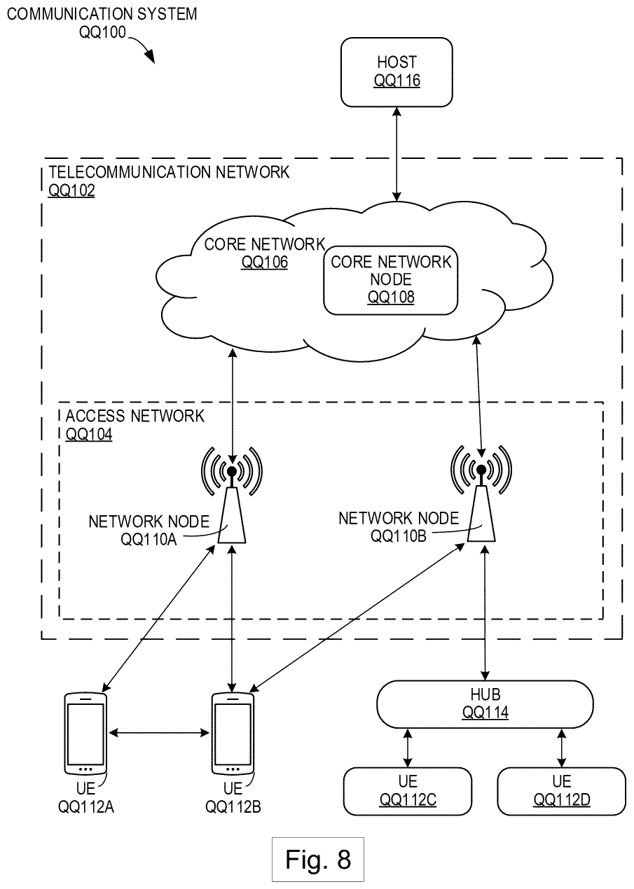

FIG. 9 shows a UE QQ200 in accordance with some embodiments. The UE QQ200 presents additional details of some embodiments of a UE such as e.g., the first UE 121 of FIG. 4 as described in example embodiments herein. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage/playback device, wearable terminal device, wireless endpoint, mobile station, tablet, laptop, laptop-embedded equipment (LEE), laptop-mounted equipment (LME), an Augmented Reality (AR) or Virtual Reality (VR) device, wireless customer-premise equipment (CPE), vehicle, vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE QQ200 includes processing circuitry QQ202 that is operatively coupled via a bus QQ204 to an input/output interface QQ206, a power source QQ208, a memory QQ210, a communication interface QQ212, and/or any other component, or any combination thereof. Certain UEs may utilize all or a subset of the components shown in 10. The level of integration between the components may vary from one UE to another UE. Further, certain UEs may contain multiple instances of a component, such as multiple processors, memories, transceivers, transmitters, receivers, etc.

The processing circuitry QQ202 is configured to process instructions and data and may be configured to implement any sequential state machine operative to execute instructions stored as machine-readable computer programs in the memory QQ210. The processing circuitry QQ202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry QQ202 may include multiple central processing units (CPUs).

In the example, the input/output interface QQ206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE QQ200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source QQ208 is structured as a battery or battery pack. Other types of power sources, such as an external power source (e.g., an electricity outlet), photovoltaic device, or power cell, may be used. The power source QQ208 may further include power circuitry for delivering power from the power source QQ208 itself, and/or an external power source, to the various parts of the UE QQ200 via input circuitry or an interface such as an electrical power cable. Delivering power may be, for example, for charging of the power source QQ208. Power circuitry may perform any formatting, converting, or other modification to the power from the power source QQ208 to make the power suitable for the respective components of the UE QQ200 to which power is supplied.

The memory QQ210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory QQ210 includes one or more application programs QQ214, such as an operating system, web browser application, a widget, gadget engine, or other application, and corresponding data QQ216. The memory QQ210 may store, for use by the UE QQ200, any of a variety of various operating systems or combinations of operating systems.

The memory QQ210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory QQ210 may allow the UE QQ200 to access instructions, application programs and the like, stored on transitory or non-transitory memory media, to off-load data, or to upload data. An article of manufacture, such as one utilizing a communication system may be tangibly embodied as or in the memory QQ210, which may be or comprise a device-readable storage medium.

The processing circuitry QQ202 may be configured to communicate with an access network or other network using the communication interface QQ212. The communication interface QQ212 may comprise one or more communication subsystems and may include or be communicatively coupled to an antenna QQ222. The communication interface QQ212 may include one or more transceivers used to communicate, such as by communicating with one or more remote transceivers of another device capable of wireless communication (e.g., another UE or a network node in an access network). Each transceiver may include a transmitter QQ218 and/or a receiver QQ220 appropriate to provide network communications (e.g., optical, electrical, frequency allocations, and so forth). Moreover, the transmitter QQ218 and receiver QQ220 may be coupled to one or more antennas (e.g., antenna QQ222) and may share circuit components, software or firmware, or alternatively be implemented separately.

In the illustrated embodiment, communication functions of the communication interface QQ212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface QQ212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE QQ200 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

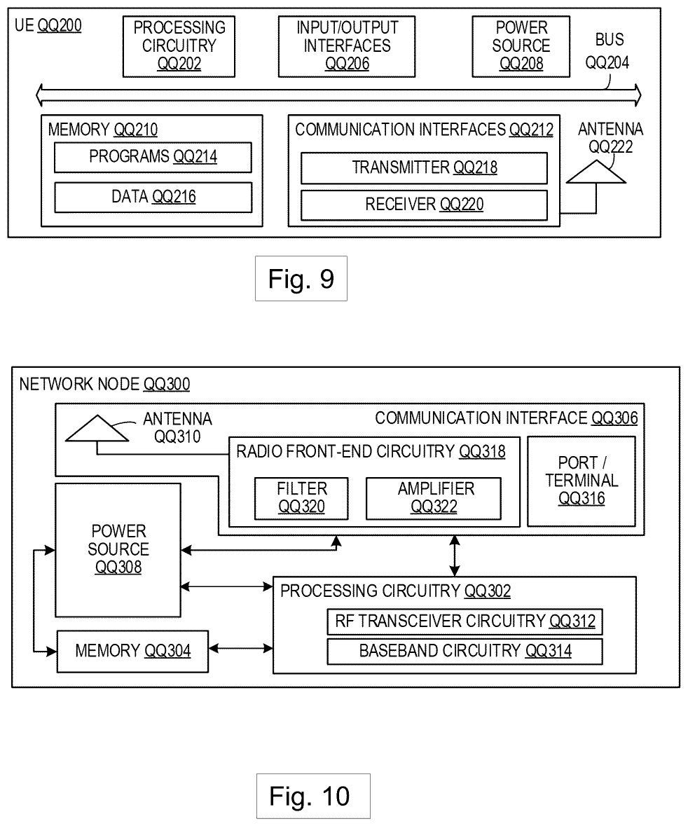

FIG. 10 shows a network node QQ300 in accordance with some embodiments. The network node QQ300 presents additional details of some embodiments of a network node such as e.g., the base station 110 of FIG. 1 as described in example embodiments herein. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)), O-RAN nodes or components of an O-RAN node (e.g., O-RU, O-DU, O-CU).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units, distributed units (e.g., in an O-RAN access node) and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node QQ300 includes a processing circuitry QQ302, a memory QQ304, a communication interface QQ306, and a power source QQ308. The network node QQ300 may be composed of multiple physically separate components (e.g., a NodeB component and a RNC component, or a BTS component and a BSC component, etc.), which may each have their own respective components. In certain scenarios in which the network node QQ300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node QQ300 may be configured to support multiple radio access technologies (RATs). In such embodiments, some components may be duplicated (e.g., separate memory QQ304 for different RATs) and some components may be reused (e.g., a same antenna QQ310 may be shared by different RATs). The network node QQ300 may also include multiple sets of the various illustrated components for different wireless technologies integrated into network node QQ300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node QQ300.

The processing circuitry QQ302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ300 components, such as the memory QQ304, to provide network node QQ300 functionality.

In some embodiments, the processing circuitry QQ302 includes a system on a chip (SOC). In some embodiments, the processing circuitry QQ302 includes one or more of radio frequency (RF) transceiver circuitry QQ312 and baseband processing circuitry QQ314. In some embodiments, the radio frequency (RF) transceiver circuitry QQ312 and the baseband processing circuitry QQ314 may be on separate chips (or sets of chips), boards, or units, such as radio units and digital units. In alternative embodiments, part or all of RF transceiver circuitry QQ312 and baseband processing circuitry QQ314 may be on the same chip or set of chips, boards, or units.

The memory QQ304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry QQ302. The memory QQ304 may store any suitable instructions, data, or information, including a computer program, software, an application including one or more of logic, rules, code, tables, and/or other instructions capable of being executed by the processing circuitry QQ302 and utilized by the network node QQ300. The memory QQ304 may be used to store any calculations made by the processing circuitry QQ302 and/or any data received via the communication interface QQ306. In some embodiments, the processing circuitry QQ302 and memory QQ304 is integrated.

The communication interface QQ306 is used in wired or wireless communication of signaling and/or data between a network node, access network, and/or UE. As illustrated, the communication interface QQ306 comprises port(s)/terminal(s) QQ316 to send and receive data, for example to and from a network over a wired connection. The communication interface QQ306 also includes radio front-end circuitry QQ318 that may be coupled to, or in certain embodiments a part of, the antenna QQ310. Radio front-end circuitry QQ318 comprises filters QQ320 and amplifiers QQ322. The radio front-end circuitry QQ318 may be connected to an antenna QQ310 and processing circuitry QQ302. The radio front-end circuitry may be configured to condition signals communicated between antenna QQ310 and processing circuitry QQ302. The radio front-end circuitry QQ318 may receive digital data that is to be sent out to other network nodes or UEs via a wireless connection. The radio front-end circuitry QQ318 may convert the digital data into a radio signal having the appropriate channel and bandwidth parameters using a combination of filters QQ320 and/or amplifiers QQ322. The radio signal may then be transmitted via the antenna QQ310. Similarly, when receiving data, the antenna QQ310 may collect radio signals which are then converted into digital data by the radio front-end circuitry QQ318. The digital data may be passed to the processing circuitry QQ302. In other embodiments, the communication interface may comprise different components and/or different combinations of components.

In certain alternative embodiments, the network node QQ300 does not include separate radio front-end circuitry QQ318, instead, the processing circuitry QQ302 includes radio front-end circuitry and is connected to the antenna QQ310. Similarly, in some embodiments, all or some of the RF transceiver circuitry QQ312 is part of the communication interface QQ306. In still other embodiments, the communication interface QQ306 includes one or more ports or terminals QQ316, the radio front-end circuitry QQ318, and the RF transceiver circuitry QQ312, as part of a radio unit (not shown), and the communication interface QQ306 communicates with the baseband processing circuitry QQ314, which is part of a digital unit (not shown).

The antenna QQ310 may include one or more antennas, or antenna arrays, configured to send and/or receive wireless signals. The antenna QQ310 may be coupled to the radio front-end circuitry QQ318 and may be any type of antenna capable of transmitting and receiving data and/or signals wirelessly. In certain embodiments, the antenna QQ310 is separate from the network node QQ300 and connectable to the network node QQ300 through an interface or port.

The antenna QQ310, communication interface QQ306, and/or the processing circuitry QQ302 may be configured to perform any receiving operations and/or certain obtaining operations described herein as being performed by the network node. Any information, data and/or signals may be received from a UE, another network node and/or any other network equipment. Similarly, the antenna QQ310, the communication interface QQ306, and/or the processing circuitry QQ302 may be configured to perform any transmitting operations described herein as being performed by the network node. Any information, data and/or signals may be transmitted to a UE, another network node and/or any other network equipment.

The power source QQ308 provides power to the various components of network node QQ300 in a form suitable for the respective components (e.g., at a voltage and current level needed for each respective component). The power source QQ308 may further comprise, or be coupled to, power management circuitry to supply the components of the network node QQ300 with power for performing the functionality described herein. For example, the network node QQ300 may be connectable to an external power source (e.g., the power grid, an electricity outlet) via an input circuitry or interface such as an electrical cable, whereby the external power source supplies power to power circuitry of the power source QQ308. As a further example, the power source QQ308 may comprise a source of power in the form of a battery or battery pack which is connected to, or integrated in, power circuitry. The battery may provide backup power should the external power source fail.

Embodiments of the network node QQ300 may include additional components beyond those shown in FIG. 10 for providing certain aspects of the network node's functionality, including any of the functionality described herein and/or any functionality necessary to support the subject matter described herein. For example, the network node QQ300 may include user interface equipment to allow input of information into the network node QQ300 and to allow output of information from the network node QQ300. This may allow a user to perform diagnostic, maintenance, repair, and other administrative functions for the network node QQ300. In some embodiments providing a core network node, such as core network node 108 of FIG. QQ1, some components, such as the radio front-end circuitry QQ318 and the RF transceiver circuitry QQ312 may be omitted.

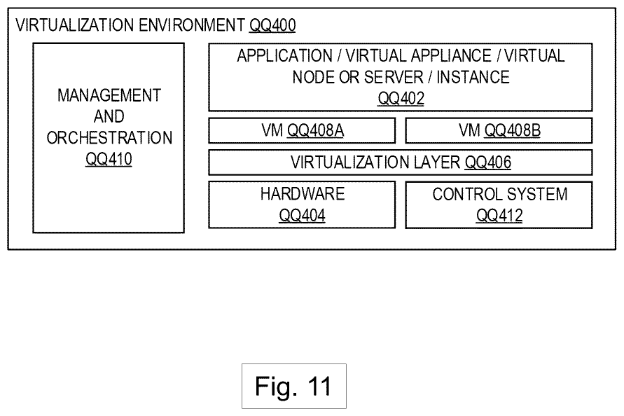

FIG. 11 is a block diagram illustrating a virtualization environment QQ400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments QQ400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized. In some embodiments, the virtualization environment QQ400 includes components defined by the O-RAN Alliance, such as an O-Cloud environment orchestrated by a Service Management and Orchestration Framework via an O-2 interface. Virtualization may facilitate distributed implementations of a network node, UE, core network node, or host.

Applications QQ402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware QQ404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers QQ406 (also referred to as hypervisors or virtual machine monitors (VMMs)), provide VMs QQ408a and QQ408b (one or more of which may be generally referred to as VMs QQ408), and/or perform any of the functions, features and/or benefits described in relation with some embodiments described herein. The virtualization layer QQ406 may present a virtual operating platform that appears like networking hardware to the VMs QQ408.

The VMs QQ408 comprise virtual processing, virtual memory, virtual networking or interface and virtual storage, and may be run by a corresponding virtualization layer QQ406. Different embodiments of the instance of a virtual appliance QQ402 may be implemented on one or more of VMs QQ408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM QQ408 may be a software implementation of a physical machine that runs programs as if they were executing on a physical, non-virtualized machine. Each of the VMs QQ408, and that part of hardware QQ404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs QQ408 on top of the hardware QQ404 and corresponds to the application QQ402.

Hardware QQ404 may be implemented in a standalone network node with generic or specific components. Hardware QQ404 may implement some functions via virtualization. Alternatively, hardware QQ404 may be part of a larger cluster of hardware (e.g. such as in a data center or CPE) where many hardware nodes work together and are managed via management and orchestration QQ410, which, among others, oversees lifecycle management of applications QQ402. In some embodiments, hardware QQ404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system QQ412 which may alternatively be used for communication between hardware nodes and radio units.

Although the computing devices described herein (e.g., UEs, network nodes) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

When using the word “comprise” or “comprising” it shall be interpreted as non-limiting, i.e. meaning “consist at least of”.

The embodiments herein are not limited to the preferred embodiments described above. Various alternatives, modifications and equivalents may be used.

### Abbreviations

BN Baseband node
CPRI Common Public Radio Interface
eAxC_ID eCPRI antenna carrier identifier
E-LMI Ethernet Local Management Interface
O-DU O-RAN distributed unit
O-RU O-RAN radio unit
OFDM Orthogonal Frequency Division Multiplexing
PUSCH Physical Uplink Shared Channel
RX Reception
RU Radio Unit
SDN Software-Defined Networking
TX Transmission
VCC-NF VLAN configuration and characterization network function
VLAN Virtual Local Area Network
VLAN ID VLAN identifier

1. A method performed by a network function for handling a set of paths between a baseband node and a radio unit in a mesh fronthaul network of a communications network, the method comprising:
establishing a set of paths between ports in a port pair, comprising a port in the baseband node and port in the radio unit, and which paths in the set of paths comprise different paths connected between the port in the baseband node and multiple endpoints associated with the port of the radio unit, where each path is associated with an individual path Identifier (ID),
for each path out of the set of paths, instructing a first node to perform a one-way delay measurement for the path associated with the individual path ID, wherein the first node is represented by anyone out of: the baseband node and the radio unit,
receiving, from the first node, results of the one-way delay measurement performed for each path out of the set of paths, and
determining how to use each path out of the set of paths based on the received results of the one-way delay measurements.

2. The method according to claim 1, further comprising:
sending an instruction to the baseband node to configure a delay window for the port in the radio unit according to the determined usage of each path out of the set of paths of the set of paths.

3. The method according to claim 1, wherein the determining of how to use the paths of the set of paths, comprises:
based on identifying a worst-case one-way delay between a set of paths for the port pair, determining to configure a single delay window and use all paths in between said port pair simultaneously.

4. The method according to claim 1, wherein the determining of how to use the paths of the set of paths, comprises:
clustering paths into a number of path clusters based on the one-way delay between the set of paths for a port pair, and
determining the number of endpoints with separate one-way delay windows that the port pair supports based on the resulting number of path clusters.

5. The method according to claim 1, further comprising:
obtaining information about a number of port pairs, between ports in the baseband node and ports in the radio unit,
wherein the establishing of the set of paths between the ports of the port pair comprises establishing a set of paths for each port pair out of the number of port pairs, and
wherein the sending of the instruction to the baseband node, to configure a delay window for the port in the radio unit according to the determined usage of each path out of the set of paths, is performed for each port pair out of the number of port pairs.

6. The method according to claim 5, wherein the determining of how to use each path out of the set of paths comprises:
clustering paths into of a number of path clusters based on the one-way delay between the set of paths for each port pair out of the number of port pairs, and
determining to use the paths that are clustered together in the number of path clusters to transmit towards anyone out of: the same endpoint or the same port in the radio unit, using the same delay window from two or more physical ports using multiple paths.

7. The method according to claim 1, further comprising:
for each path out of the set of paths, configuring a packet forwarding node related to the path, which packet forwarding node is configured with the individual path ID assigned to the path.

8. A non-transitory computer-readable medium comprising, stored thereupon, a computer program comprising instructions, which when executed by a processor in a network function, causes the processor to perform actions according to claim 1.

9. A network function configured to handle a set of paths between a baseband node and a radio unit in a mesh fronthaul network of a communications network, the network function further being configured to:
establish a set of paths between ports in a port pair, comprising a port in the baseband node and port in the radio unit, and which paths in the set of paths are adapted to comprise different paths connected between the port in the baseband node and multiple endpoints associated with the port of the radio unit, where each path is adapted to be associated with an individual path Identifier (ID),
for each path out of the set of paths, instruct a first node to perform a one-way delay measurement for the path associated with the individual path ID, wherein the first node is represented by anyone out of: the baseband node and the radio unit,
receive results of the one-way delay measurement performed for each path out of the set of paths, and
determine how to use each path out of the set of paths based on the received results of the one-way delay measurements.

10. The network function according to claim 9, further being configured to:
send an instruction to the baseband node, to configure a delay window for the port in the radio unit according to the determined usage of each path out of the set of paths.

11. The network function according to claim 9, further being configured to determine how to use each path out of the set of paths by:
based on identifying a worst-case one-way delay between a set of paths for the port pair, determine to configure a single delay window and use all paths in between said port pair simultaneously.

12. The network function according to claim 9, further being configured to determine how to use the paths of the set of paths, by:
clustering paths into a number of path clusters based on the one-way delay between the set of paths for a port pair, and
determining the number of endpoints with separate one-way delay windows that the port pair supports based on the resulting number of path clusters.

13. The network function according to claim 9, further being configured to:
obtain formation about a number of port pairs, between ports in the baseband node and ports in the radio unit,
establish the set of paths between the ports of the port pair by establishing a set of paths for each port pair out of the number of port pairs, and
send the instruction to the baseband node, to configure a delay window for the port in the radio unit according to the determined usage of each path out of the set of paths, by sending the instruction for each port pair out of the number of port pairs.

14. The network function according to claim 13, further being configured to determine how to use each path out of the set of paths by:
clustering paths into of a number of path clusters based on the one-way delay between the set of paths for each port pair out of the number of port pairs, and
determining to use the paths that are clustered together in the number of path clusters to transmit towards anyone out of: the same endpoint or the same port in the radio unit, using the same delay window from two or more physical ports using multiple paths.

15. The network function according to claim 9, further being configured to:
for each path out of the set of paths, configure a packet forwarding node related to the path, which packet forwarding node is adapted to be configured with the individual path ID assigned to the path.
